(19) United States
(12) Patent Application Publication
(10) Pub. No.: US 2004/0005442 A1
(43) Pub. Date: Jan. 8, 2004

(54) Resin product having flow patterns and manufacturing method therefor

(75) Inventor: Tomohiro Sekine, Tokyo (JP)

Correspondence Address: Marc A. Rossi, ROSSI & ASSOCIATES, P.O. Box 826, Ashburn, VA, 20146-0826, US

(73) Assignee: Mitsubishi Jidosha Kogyo Kabushiki Kaisha

(21) Appl. No.: 10/621,249

(22) Filed: Jul. 16, 2003

Related U.S. Application Data
(63) Continuation of application No. PCT/JP02/09434, filed on Sep. 13, 2002.

(30) Foreign Application Priority Data
Sep. 18, 2001 (JP) 2001-283940

(51) Int. Cl. B32B 5/16

(52) U.S. Cl. 428/207; 264/73

(57) ABSTRACT

A manufacturing method for a resin product having flow patterns uses a resin material, which is obtained by compounding a base material having a given ground color and a colorant having brightness different from that of the ground color. An injection-molded article having the flow patterns is obtained by injection-molding the resin material by means of an injection molding machine. A colored clear layer having a color different from that of the base material is spread over the surface of the injection-molded article. The resin product having the flow patterns that are adjusted to a desired product color is obtained by combining the respective hues of the ground color of the base material and the flow patterns and the hue of the colored clear layer.

### CROSS-REFERENCE TO RELATED APPLICATIONS

This is a Continuation Application of PCT Application No. PCT/JP02/09434, filed Sep. 13, 2002, which was not published under PCT Article 21(2) in English.

This application is based upon and claims the benefit of priority from the prior Japanese Patent Application No. 2001-283940, filed Sep. 18, 2001, the entire contents of which are incorporated herein by reference.

### BACKGROUND OF THE INVENTION

1. Field of the Invention

The present invention relates to a resin product having, for example, woodgrain or grained (marbled) flow patterns on it surface and a manufacturing method therefor.

2. Description of the Related Art

Large-sized parts such as a meter panel, as well as small-sized parts such as an inside handle cover, are used as trim materials of an automobile. A lot of woodgrain resin products are used to enhance the texture of these trim materials. For popular cars, in particular, the woodgrain texture is expected to be obtained at low cost.

Two methods, the hydraulic transfer method and the film insert method, are conventionally used to manufacture resin products that have flow patterns such as woodgrain patterns. In order to obtain the same texture of wooden parts, according to these manufacturing methods, the surface of an injection-molded article is figured with woodgrain patterns.

According to the hydraulic transfer method, a water-soluble film that is photogravured with woodgrain patterns is floated on the surface of the water. The resin molded article is placed on the film and pressurized. Thereupon, the woodgrain patterns of the film are transferred to the surface of the resin molded article.

According to the film insert method, on the other hand, the woodgrain film is previously set on the inner surface of a die of an injection molding machine in molding the resin product by means of the injection molding machine. The woodgrain patterns are transferred to the surface of the injection-molded article as a resin is injected into the die.

In either of the methods, however, the woodgrain film requires its manufacturing apparatus. Besides, the hydraulic transfer method requires an apparatus for transferring the woodgrain patterns of the film to the surface of the resin molded article. On the other hand, the film insert method requires an apparatus for setting the woodgrain film on the inner surface of the die. Thus, either of the methods requires special equipment. Therefore, the manufacturing cost is high.

As is known from Jpn. Pat. Appln. KOKAI Publication No. 54-154456, 54-34368, or 6-80821, for example, on the other hand, a resin product having flow patterns may be obtained by injection molding only. A resin material used in this manufacturing method is a mixture of a base material, as a body material, and a colored resin material (colored resin that forms patterns) that cannot be easily dissolved in the base material. If this resin material is injection-molded by means of an injection molding machine, traces of flow of the colored resin remains on the surface of a molded article, so that patterns that resemble the grain of wood appear on the surface of the injection-molded article.

The method in which the flow patterns are thus obtained by utilizing the traces of flow of the resin during the injection molding operation, unlike the hydraulic transfer method and the film insert method mentioned before, requires no special equipment, so that it can be carried out at low cost.

If the traces of flow of the resin are utilized for the formation of the flow patterns, as in the conventional method described above, however, the woodgrain patterns depend only on the respective colors of the base material and the colored resin that forms the traces of flow. Therefore, it is hard to obtain patterns that have desired woodgrain patterns or a desired contrast.

The inventors hereof tried injection molding to form flow patterns by the use of base materials having ground colors of yellow, brown, white, etc. In any case, the ground color was too light or too dark to maintain the flow patterns, so that desired flow patterns were not able to be obtained.

### BRIEF SUMMARY OF THE INVENTION

The object of the present invention is to provide a resin product, capable of easily obtaining flow patterns having various colors and contrasts without requiring any special equipment, and a manufacturing method therefor.

A resin product of the present invention comprises: an injection-molded article formed of a resin material, obtained by compounding a base material having a given ground color and a colorant having brightness and/or a hue different from that of the ground color, and injection-molded so that flow patterns based on the ground color of the base material and the colorant appear on the surface; and a colored clear layer formed of a colored clear paint of a color different from the ground color, the colored clear layer being spread over the surface of the injection-molded article so that the respective hues of the ground color and the flow patterns and the hue of the colored clear paint are combined to be adjusted to a desired product color.

A manufacturing method of the present invention comprises: an injection molding process of injection-molding a resin material, obtained by compounding a base material having a given ground color and a colorant having brightness and/or a hue different from that of the ground color, by means of an injection molding machine having a cylinder and a screw so that flow patterns based on the ground color of the base material and the colorant appear on the surface, thereby obtaining an injection-molded article having the flow patterns; and a colored clear coating process of spreading a colored clear paint of a color different from the ground color over the surface of the injection-molded article so that the respective hues of the ground color and the flow patterns and the hue of the colored clear paint are combined to be adjusted to a desired product color.

The resin product having the flow patterns, which is manufactured according to the present invention, is manufactured undergoing the injection molding process and the colored clear coating process. In the injection molding process, the design and contrast of the flow patterns can be adjusted. In the colored clear coating process, the hue of the final product is adjusted without failing to making the most of the flow patterns. Thus, the woodgrain or marbled (grained) resin product having the flow patterns with a desired color and contrast can be obtained by selecting the combination of the resin material used in the injection molding process and the colored clear paint used in the colored clear coating process. Further, unevenness of the flow patterns in color can be obscured by means of the colored clear layer, so that the obtained resin product having the flow patterns can enjoy good quality.

In a preferred mode of the present invention, a plurality of colorants having different colors may be selectively used so that the variation of the flow patterns can be enhanced. In a preferred mode of the present invention, moreover, a sheen material may be compounded with the base material so that the depth of the flow patterns can be emphasized.

### BRIEF DESCRIPTION OF THE SEVERAL VIEWS OF THE DRAWING

FIG. 1 is a sectional view of an injection molding machine used for the manufacture of a resin product according to one embodiment of the present invention;

FIG. 2 is a perspective view of a resin product having flow patterns according to the one embodiment of the present invention, taken before colored clear coating;

FIG. 3 is an enlarged view of a part of the resin product designated by F3 in FIG. 2;

FIG. 4 is a schematic view showing a coating apparatus used in a colored clear coating process of a manufacturing method for a resin product according to the one embodiment of the present invention;

FIG. 5 is a perspective view of the resin product having the flow patterns according to the one embodiment of the present invention;

FIG. 6 is sectional view of the resin product taken along line F6-F6 of FIG. 5; and

FIG. 7 is a block diagram showing processes of manufacture of the resin product according to the one embodiment of the present invention.

### DETAILED DESCRIPTION OF THE INVENTION

One embodiment of the present invention will now be described with reference to FIGS. 1 to 7.

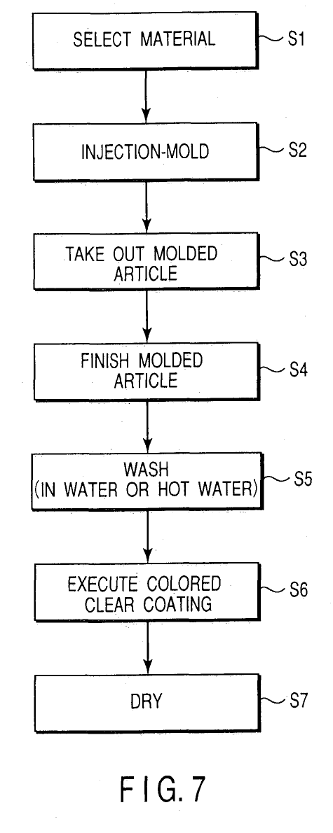

FIG. 5 shows a woodgrain handle cover, a trim material of an automobile, as an example of a resin product A that has flow patterns 10a. The resin product A (handle cover) is attached to the periphery of a door operating handle inside a door. FIG. 7 shows processes of a manufacturing method for the resin product A that has the flow patterns 10a.

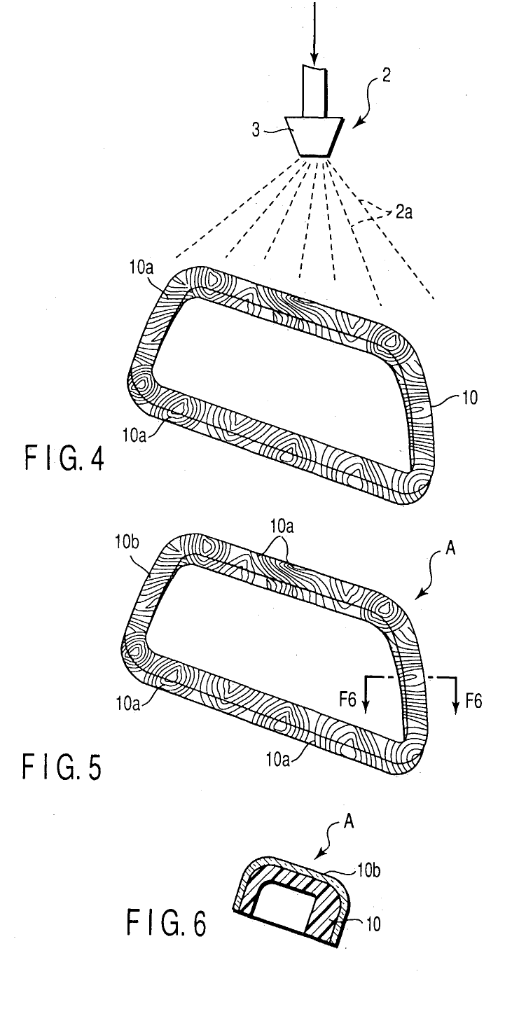

As shown in FIG. 6, the resin product A that has the flow patterns includes an injection-molded article 10 and a colored clear layer 10b that covers the outside of the injection-molded article 10. The injection-molded article 10 can be molded by means of a conventional injection molding machine 1 shown in FIG. 1, as mentioned later. The colored clear layer 10b can be formed by coating by means of a conventional coating apparatus 2 shown in FIG. 4.

In manufacturing the woodgrain resin product A, a resin material 5 is selected so that flow patterns with a desired clear contrast can be obtained (Step S1 in FIG. 7). The resin material 5 is used in the injection molding machine 1, as shown in FIG. 1.

The resin material 5 is based on a base material 6 of a high-brightness ground color, which is a composite material containing PC (polycarbonate) and ABS (acrylonitrile-butadiene-styrene resin) in pellets, for example. An example of the ground color of the base material 6 is green. The base material 6 is compounded with a low-brightness colorant 7 that is used to form patterns and, for example, titanium particles (golden) for use as a sheen material 8.

A coloring resin of a plurality of hues that is different from the base material 6 in brightness is used as the colorant 7. A composite material that is based on PC and ABS and colored red, for example, and a composite material that is based on PC and ABS and colored black are used as the coloring resin.

In order to prevent excessive fusion with the base material 6, a highly viscous noncrystalline resin having no distinct melting point is suitably used as the colorant 7. The colorant 7 and the sheen material 8 are added at the rate of, for example, 5 parts by weight compared to 100 parts by weight of the base material 6. A coloring material having the same hue with and lower in brightness than the base material 6 may be used as the colorant 7.

The base material 6, colorant 7, and sheen material 8 blended in this manner are supplied to the injection molding machine 1. The injection molding machine 1 shown in FIG. 1 has a cylinder 20, screw 21, material supply section 22, nozzle 23, die 1a, etc. The injection-molded article 10 having the same shape with the resin product A is molded by injecting the resin material 5 into the die 1a by means of the injection molding machine 1. Thus, an injection molding process of Step S2 in FIG. 7 is carried out.

In this injection molding process, the temperature of the cylinder 20 is set to be lower than in the case of injection molding of regular resin products, and the injection speed is set to be lower. More specifically, the temperature of the cylinder 20 of the injection molding machine 1 is adjusted by means of a heater (not shown). By way of example, temperatures near the nozzle 23 and the material supply section 22 are set at about 215° C. and 200° C., respectively.

As described above, the temperature on the rear part side of the cylinder 20 is made lower than the temperature on the distal end side of the cylinder 20. This is done in order to restrain the colorant 7 for obtaining the flow patterns 10a from excessively fusing with the base material 6, thereby leaving positive traces of flow, at the material supply section 22. In the region near the nozzle 23, the resin material 5 can be given suitable fluidity for injection by doing this.

In carrying out injection for one product, the injection molding machine 1 varies the speed of movement in the direction of the axis X of the screw 21 in a plurality of stages. In the initial stage of movement, for example, the screw 21 is moved at low speed, and the injection is speeded up thereafter. If the stroke of the screw 21 for each product and the maximum speed are 95 mm and 100%, for example, the moving speed (%) of the screw 21 for the injection for each product, for the distance from the advanced end of the screw, is

(1) 3% for a section at 80 mm to 95 mm from the advanced end,

(2) 2% for a section at 73 mm to 80 mm from the advanced end,

(3) 12% for a section at 13 mm to 73 mm from the advanced end, or

(4) 30% for a section at 0 mm to 13 mm from the advanced end.

The colorant 7 used may be a pigment for restraining excessive fusion with the base material 6 or a noncrystalline resin that can restrain excessive fusion. Therefore, the colorant 7 can flow in the die 1a without merging into the base material 6 during injection molding operation. Thus, traces of flow of the colorant 7 remain positively on the surface of the injection-molded article 10. These traces of flow develop into the flow patterns 10a for the ground color (green in this case) of the base material 6.

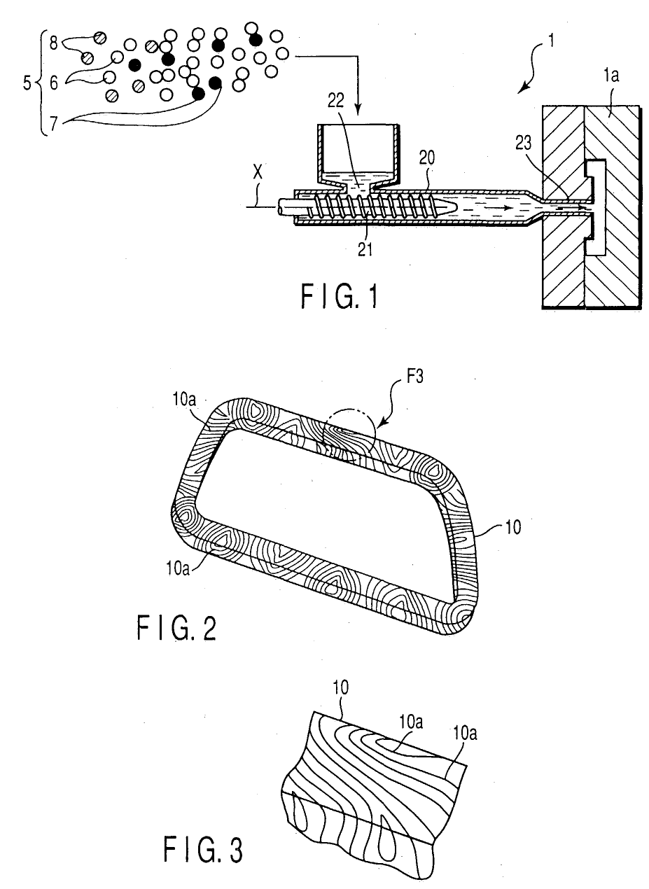

Thus, the injection molding machine 10 having flow patterns 10a based on the colorant 7 can be obtained in the die 1a, as shown in FIGS. 2 and 3. The flow patterns 10a formed of the dark-colored colorant 7 are in high contrast to the ground color of the base material 6.

The design and contrast of the flow patterns 10a can be adjusted by selecting the base material 6, colorant 7, sheen material 8, etc. and controlling injection conditions (screw speed, cylinder temperature, etc.) in the processes (Steps S1 and S2) described above. Thus, the flow patterns 10a can be obtained in contrast to the desired flow patterns 10a.

After the injection molding process is carried out, the injection-molded article 10 is taken out of the die 1a (Step S3 in FIG. 7). Further, the injection-molded article 10 having a desired shape is obtained by cleanly finishing traces of material injection ports and the like in the injection-molded article 10 (Step S4).

In order to remove soil and dust adhering to the surface of the injection-molded article 10, thereafter, washing in water or hot water is carried out (Step S5 in FIG. 7). The washed injection-molded article 10 is carried into the coating apparatus 2 shown in FIG. 4.

In the coating apparatus 2, a colored clear coating process of Step S6 in FIG. 7 is carried out by means of a coating nozzle 3. More specifically, a brownish colored clear paint 2a, which is a paint itself compounded with a brownish pigment, is spread over the surface of the injection-molded article 10, e.g., an exposed surface inside an automobile.

In the colored clear coating process (Step S6) described above, the resin product A coated with the colored clear layer 10b on it surface is obtained, as shown in FIGS. 5 and 6.

In the colored clear coating process, the color of the colored clear paint 2a is selected so that a desired woodgrain tone can be obtained. If a light brownish color is used for the colored clear paint 2a, for example, the high-brightness ground color (greenish) of the injection-molded article 10 changes into light brown. Further, the dark-colored contrasty flow patterns 10a on the surface of the injection-molded article 10 are superposed on the brown color of the colored clear paint 2a to form darker flow patterns 10a, so that the contrast is enhanced.

Furthermore, the depth of the patterns 10a is increased by the visual effect of the colored clear layer 10b on the flow patterns 10a. Thus, the color, contrast, and depth of the resin product A can be adjusted by suitably selecting the combination of the patterns 10a of the injection-molded article 10 and their color and the clear color of the colored clear layer 10b.

As described above, woodgrain resin products A of various colors can be obtained by adjusting the ground color and the flow patterns 10a of the injection-molded article 10 and the hue of the colored clear layer 10b. The depth of the surface of the resin products A can be also adjusted depending on the quantity of the sheen material 8 that is compounded with the base material 6.

As described above, the resin product A having the flow patterns 10a is manufactured undergoing the injection molding process (Step S2) and the colored clear coating process (Step S6). In the injection molding process, the design and contrast of the flow patterns 10a can be adjusted. In the colored clear coating process, the hue of the final product A is adjusted without failing to making the most of the flow patterns 10a. Thus, the woodgrain resin product A having a desired color and contrast can be obtained, for example, for each car model by carefully selecting the combination of the resin material 5 used in the injection molding process and the colored clear paint 2a used in the colored clear coating process.

Further, the design and hue of the flow patterns 10a can be adjusted, and besides, unevenness of the flow patterns 10a in color can be obscured by means of the colored clear layer 10b, so that the obtained woodgrain resin product A can enjoy good quality.

Furthermore, the variation of the flow patterns can be enhanced by selectively using colorants 7 of a plurality of colors in the injection molding process (Step S2). In addition, the depth of the surface of the resin product A can be emphasized by compounding the sheen material 8 with the base material 6. In this case, the range of adjustment of the depth can be widened by selectively compounding a plurality of kinds of sheen materials 8.

The manufacture of the woodgrain resin product A of the present embodiment requires no special equipment. Thus, the resin product A having beautiful woodgrain patterns can be manufactured at low cost with use of the conventional injection molding machine 1 and the coating apparatus 2.

The present invention is not limited to the embodiment described above, and various changes may be effected therein without departing from the scope or spirit of the invention. For example, the ground color of the base material is not limited to green, and the base material used may be of any other high-brightness color, e.g., a whitish or yellowish color.

Further, the present invention is not limited to a woodgrain handle cover, and it may alternatively be applied to any other resin product or any other resin product than an interior material. Furthermore, it may be applied to a resin product that has any other flow patterns than woodgrain ones, e.g., marbled flow patterns.

What is claimed is:

1. A resin product having flow patterns, comprising:
an injection-molded article formed of a resin material, obtained by compounding a base material having a given ground color and a colorant having brightness and/or a hue different from that of the ground color, and injection-molded so that flow patterns based on the ground color of the base material and the colorant appear on the surface; and
a colored clear layer formed of a colored clear paint of a color different from the ground color, the colored clear layer being spread over the surface of the injection-molded article so that the respective hues of the ground color and the flow patterns and the hue of the colored clear paint are combined to be adjusted to a desired product color.

2. A manufacturing method for a resin product having flow patterns, comprising:
an injection molding process of injection-molding a resin material, obtained by compounding a base material having a given ground color and a colorant having brightness and/or a hue different from that of the ground color, by means of an injection molding machine having a cylinder and a screw so that flow patterns based on the ground color of the base material and the colorant appear on the surface, thereby obtaining an injection-molded article having the flow patterns; and
a colored clear coating process of spreading a colored clear paint of a color different from the ground color over the surface of the injection-molded article so that the respective hues of the ground color and the flow patterns and the hue of the colored clear paint are combined to be adjusted to a desired product color.

3. A manufacturing method for a resin product having flow patterns according to claim 2, wherein the colorant is a composite material formed of a plurality of colorants having different colors.

4. A manufacturing method for a resin product having flow patterns according to claim 2 or 3, wherein the base material is compounded with a sheen material.

5. A manufacturing method for a resin product having flow patterns according to claim 2, wherein the temperature of the region near a material supply section of the cylinder of the injection molding machine is set to be lower than the temperature of the region near a nozzle of the cylinder.

6. A manufacturing method for a resin product having flow patterns according to claim 5, wherein the moving speed of the screw of the injection molding machine in the axial direction is set to be lower in the initial stage of movement than in the late stage of movement.
